(19) United States
(12) Patent Application Publication
(10) Pub. No.: US 2019/0340699 A1
(43) Pub. Date: Nov. 7, 2019

(54) Computerized Method for Calculating a Port Disbursement Account

(71) Applicant: Khaldon Khaled AL-KARMADI, Dubai (AE)

(72) Inventor: Khaldon Khaled AL-KARMADI, Dubai (AE)

(21) Appl. No.: 15/970,896

(22) Filed: May 4, 2018

(51) Int. Cl. G06Q 40/00; G06Q 50/30; G06Q 20/10; G06F 17/11

(52) U.S. Cl. CPC G06Q 40/10; G06F 17/11; G06Q 20/102; G06Q 50/30

(57) ABSTRACT

A computerized method to calculate any Port Disbursement Account with breakdown of every item for any port regardless of the differences in port tariffs, port rules and ways of calculating any item in a Disbursement Account includes the steps of: inserting and storing the port tariff rates and rules for any new port in few minutes using simple configurations steps without any additional programming; and an algorithm capable of using the user inputs, the stored port tariff rates and the pre-defined rules in calculating all the elements of a Disbursement Account.

### BACKGROUND OF THE INVENTION

There are only very few software's available which are trying to calculate a port Disbursement Account (DA). However, they are programmed to work only for specific ports and relatively having very low accuracy because of providing lump sum Disbursement Account amount without any breakdown of DA items/charges.

### BRIEF SUMMARY OF THE INVENTION

The competitive advantage of the presented software is the ability to calculate a port Disbursement Account accurately with breakdown of every item for any port regardless of the differences in port tariffs, port rules and ways of calculating every item in a Disbursement Account. This unique feature exists only because of the complex algorithm used to build this software. Almost every element in the DA depends on the port tariff which is different for every different vessel specifications, cargo specifications and port rules in any country in the world. That complexity of calculating each element in the DA does not only makes every DA a special case, but it also makes developing software for each port a special case which can take weeks or months depending on the team size. However, the presented algorithm allows the admin to insert a totally new port by applying simple configuration steps in few minutes.

### BRIEF DESCRIPTION OF THE DRAWINGS

FIG. 1: DA Calculator Flowchart which shows the overall flow of the algorithm.

FIG. 2: Calculate Number of Days at Berth Flowchart which shows how to calculate the estimated number of days the vessel will stay at berth.

FIG. 3: Calculate Subcategory Flowchart which shows how to calculate a subcategory/item/charge in a DA.

FIG. 4: Get Rate Unit Flowchart which shows how to get the rateunitvalue[0], rateunitvalue[1], rateunitvalue[2], ratevalue and ratio of the rate object using the rate unit, which was selected among the rate unit list, and User Inputs which were inserted by the user as shown in figure number 1.

FIG. 5: DA Formula Flowchart which calculates the Final_Rate of a DA item.

FIG. 6: Overall System Flowchart which shows the overall flow of the system.

### DETAILED DESCRIPTION OF THE INVENTION

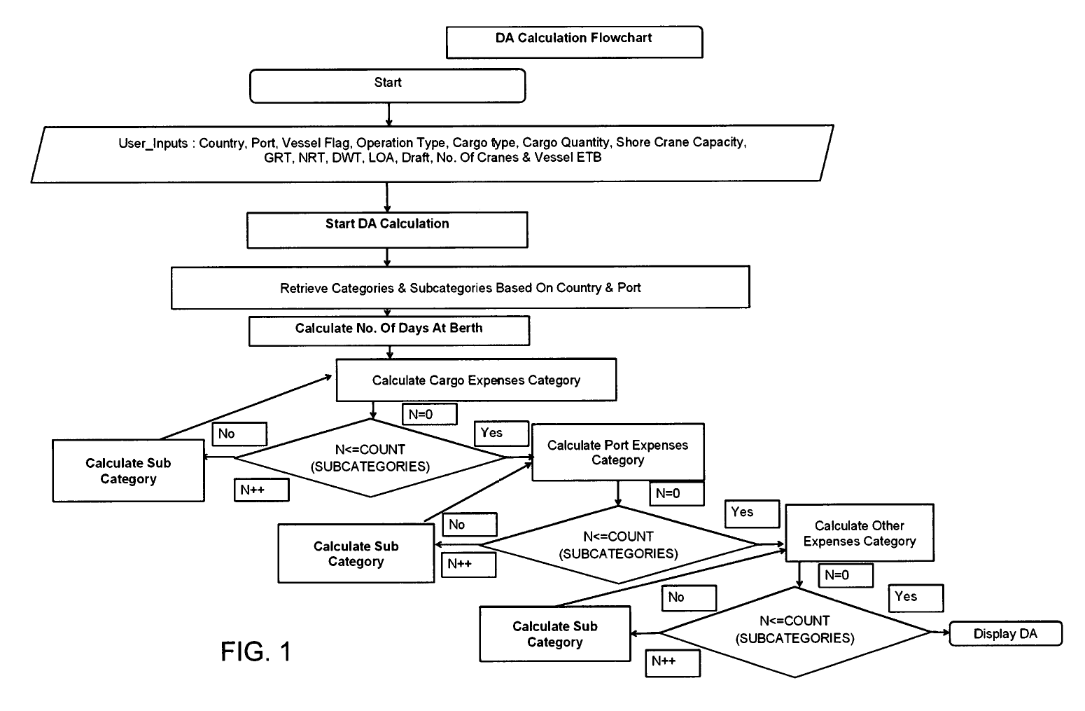

As shown in FIG. 1, the algorithm will start by getting some input parameters of the operation, vessel and cargo specifications; such as Country, Port, Vessel Flag, Operation Type, Operation Terms, Cargo Type, Cargo Quantity, Shore Crane Capacity, GRT (Gross Tonnage), NRT (Net Tonnage), DWT (Dead Weight Tonnage), LOA (Length Over All), Draft, Width, Depth Moulded, Number of Cranes and Vessel ETB (Expected Time of Berthing). Then based on the selected country and port, the system will retrieve the stored port tariff categories and subcategories which have been inserted by the admin. In addition, the algorithm will calculate the expected number of days the vessel will stay at berth. Then, it will loop through the cargo expenses, port expenses and other expenses categories to calculate each subcategory amount under those 3 categories. Finally, it will display all the calculated subcategories which represent the DA items amounts.

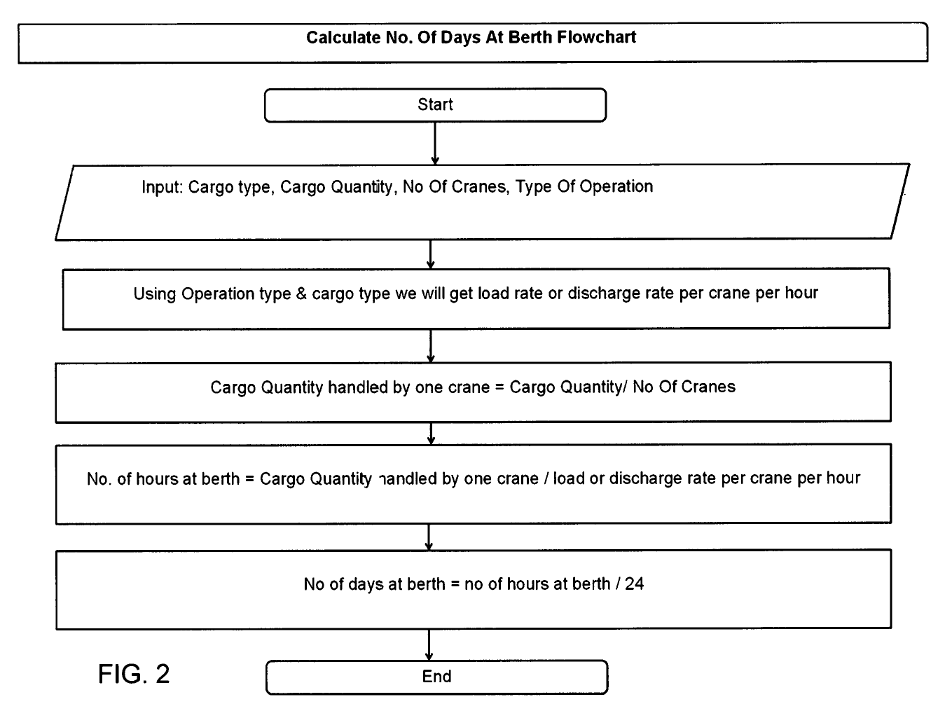

As shown above in FIG. 2, to calculate the number of days at berth the algorithm will use the operation type and cargo type to get the stored load or discharge rate per crane per hour of that cargo type. Then, it will divide the cargo quantity by the number of cranes to get the cargo quantity handled by one crane. Finally, the algorithm will divide the cargo quantity handled by one crane by load or discharge rate per crane per hour to get the number of hours at berth which can be divided by 24 to get the number of days at berth.

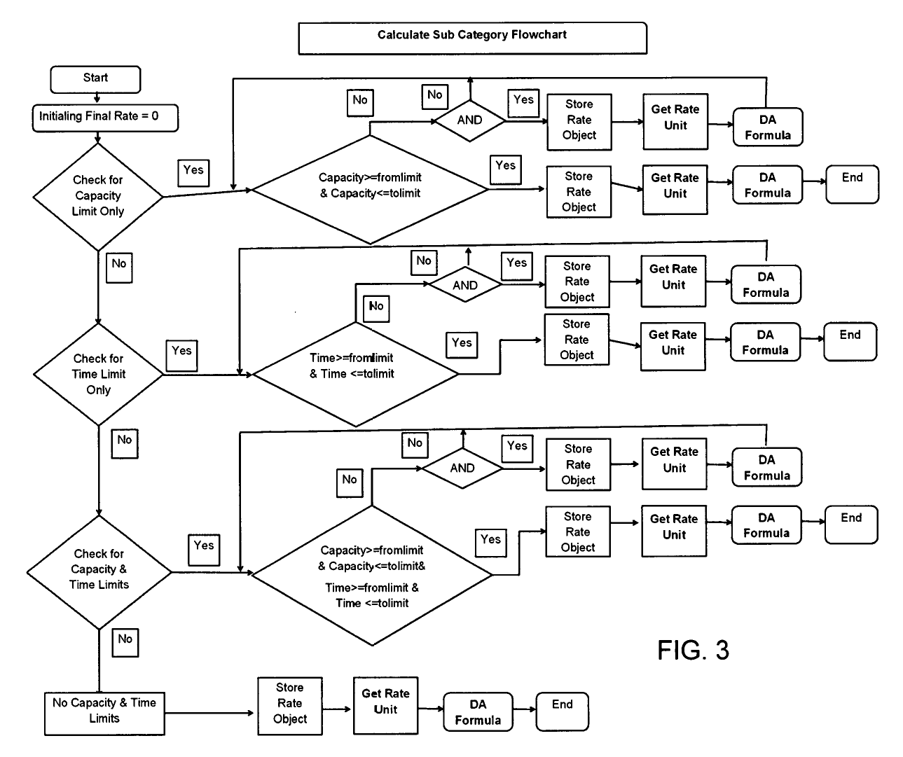

As shown in FIG. 3, to calculate each subcategory first the algorithm is initializing the final rate to 0 and checking the pre-defined capacity limits and time limits of the subcategory. Capacity limits can be using vessel DWT, GRT, NRT, LOA, draft, volume cargo quantity or any other capacity variable. Time limits can be using days or hours of operation. If a capacity limit was selected then the selected capacity limit will be used for comparison with the ranges to get the rate. If a time limit was selected then the selected time limit will be used for comparison with the ranges to get the rate. If capacity limit and time limit were selected then the selected capacity limit and time limit will be used for comparison with the ranges to get the rate. If no capacity limit and no time limit were selected then the rate will be directly selected without any comparison. For example, if capacity limit was selected as GRT and there are 2 pre-defined ranges for GRT as following from 0 to 10,000 GRT for a rate of 0.5 USD and from 10,000 to 20,000 GRT for a rate of 0.4 USD. If the input vessel GRT is 15,000 then the second rate of 0.4 USD will be selected. After selecting the rate the algorithm will call the GetRateUnit function with sending as an input the selected rate object and the user inputs to get the rate unit of that object. Then, it will call the DA Formula with an input of the rate object and FinalRate variable. Finally, the algorithm will break unless the AND Condition flag for the selected subcategory is set to 1. If the AND Condition flag is set to 1 means the selected subcategory will be calculated by accumulating more than one condition and rate. For example, if the AND Condition flag for a subcategory was set as 1 and the time limit was selected as days with 2 pre-defined ranges from 0 to 3 days for a rate of 0.5 USD and from 3 to 7 days for 0.4 USD. If the calculated number of days at berth is equal to 5 days then for the first 3 days the algorithm will use the rate value of 0.5 USD for calculating the first loop and in the second loop it will use the rate value of 0.4 USD to calculate for the balanced 2 days then it will break.

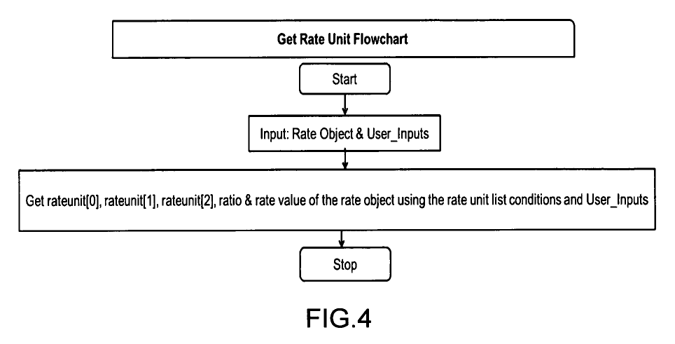

As shown in FIG. 4, the Get Rate Unit function will use the pre-defined Rate Unit of the selected Rate Object and the user inputs to assign the values of the rate objects.

Rate Object: is an object which consists of ratevalue, ratio, rateunitvalue[0], rateunitvalue[1], rateunitvalue[2] and Rate Unit.

Rate Unit: is the pre-defined rate unit of the rate value (rate units can be: Per GRT, Per GRT Per Day, Per Day, Lumpsum . . . ect).

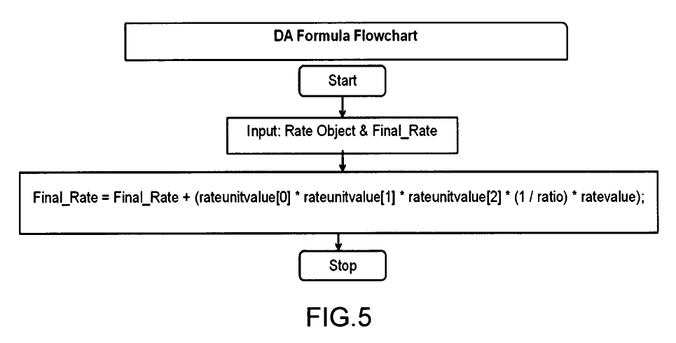

As shown in FIG. 5, the DA Formula will use the Rate Object values and the initial Final Rate variable as an input to calculate the Final Rate of the subcategory/DA item.

Final_Rate: is the final calculation value of the subcategory (subcategory can be: Port Dues, Tug Charges, Pilotage . . . ect).

rateunitvalue[0]: is the capacity value (capacity can be: DWT, GRT, NRT, LOA, FTON . . . ).

rateunitvalue[1]: is the time value (time can be in Days or Hours).

rateunitvalue[2]: is the pre-defined number of equipment's used in the operation of the subcategory (equipment's can be: Tugs, Pilot Launch . . . ect).

ratevalue: is the selected unit price of the subcategory (based on the Port Tariffs).

ratio: is the ratio used in order to apply the ratevalue (example: 10 USD Per 100 GRT and in this case 100 is the ratio).

Example (OR CONDITION):

In port X the tariff of the (Port Dues is 10 USD Per 100 GRT Per Day). Given that vessel (GRT is 33000), (Cargo Quantity is 50000 FTONS) Of Steel Billets, (Number of Cranes is 4), (Discharge Rate is 100 FTONS Per Crane Per Hour). Find The Final_Rate Of Port Dues?

Answer:

Cargo Quantity Handled By One Crane=Cargo Quantity/No Of Cranes; (as shown in FIG. 2)

Cargo Quantity Handled By One Crane=50000/4=12500 FTONS

Number of Hours at Berth=Cargo Quantity Handled By One Crane/Discharge Rate Per Crane Per Hour; (as shown in FIG. 2)

Number of Hours at Berth=12500/100=125 Hours

Number of Days at Berth=Number of Hours at Berth/24; (as shown in FIG. 2)

Number of Days at Berth=125/24=5.208 Days

Rate Unit=Per GRT Per Day

Rateunitvalue[0]=GRT=33000

Rateunitvalue[1]=Days=5.208

Rateunitvalue[2]=No Equipment's used so by default value=1

Ratevalue=10

Ratio=100

Final_Rate initialized to value=0

Final_Rate=Final_Rate+(rateunitvalue[0] *rateunitvalue[1]*rateunitvalue[2] *(1/ratio)*ratevalue); (as shown in FIG. 5)

Final_Rate=0+(33000*5.208*1*(1/100)*10)=17186.4 USD

Example (AND CONDITION):

In port X the tariff of the (Port Dues is 10 USD Per 100 GRT Per Day (From 0 To 3 Days) and (After 3 Days) is 8 USD Per 100 GRT Per Day). Given that vessel (GRT is 33000), (Cargo Quantity is 50000 FTONS) Of Steel Billets, (Number of Cranes is 4), (Discharge Rate is 100 FTONS Per Crane Per Hour). Find The Final_Rate Of Port Dues?

Answer:

Cargo Quantity Handled By One Crane=Cargo Quantity/No Of Cranes; (as shown in FIG. 2)

Cargo Quantity Handled By One Crane=50000/4=12500 FTONS

Number of Hours at Berth=Cargo Quantity Handled By One Crane/Discharge Rate Per Crane Per Hour; (as shown in FIG. 2)

Number of Hours at Berth=12500/100=125 Hours

Number of Days at Berth=Number of Hours at Berth/24; (as shown in FIG. 2)

Number of Days at Berth=125/24=5.208 Days

Days=3 Days

Rate Unit=Per GRT Per Day

Rateunitvalue[0]=GRT=33000

Rateunitvalue[1]=Days=3

Rateunitvalue[2]=No Equipment's used so by default value=1

Ratevalue=10

Ratio=100

Final_Rate initialized to value=0

Final_Rate=Final_Rate+(rateunitvalue[0] *rateunitvalue[1] *rateunitvalue[2] *(1/ratio)*ratevalue); (as shown in FIG. 5)

Final_Rate=0+(33000*3*1*(1/100)*10)=9900 USD

Then It will Loop Again To Calculate For The Balance Number Of Days

Days=5.208−3=2.208 Days

Rate Unit=Per GRT Per Day

Rateunitvalue[0]=GRT=33000

Rateunitvalue[1]=Days=2.208

Rateunitvalue[2]=No Equipment's used so by default value=1

Ratevalue=8

Ratio=100

Final_Rate=9900 (From The Last Loop)

Final_Rate=Final_Rate+(rateunitvalue[0] *rateunitvalue[1] *rateunitvalue[2] *(1/ratio)*ratevalue); (as shown in FIG. 5)

Final_Rate=9900+(33000*2.208*1*(1/100)*8)=15729.12 USD

End

As a result, the above algorithm will be able to calculate any subcategory of any DA for any port regardless of the differences in port tariffs, port rules and ways of calculating every item in a DA. In addition, the algorithm will be using the pre-defined port tariffs and rules which were inserted by the admin or any authorized user. The admin or any authorized user will be able to configure the port tariffs and rules of any new port in few minutes without any additional programming. They just need to add a new country and new port then start inserting the pre-defined port tariffs and rules of each subcategory under the port expenses, cargo expenses and other expenses categories. Port expenses and other expenses will be used for the subcategories which do not depend on the cargo of the vessel. The cargo expenses will be used for the subcategories which depend on the cargo of the vessel and it will give the admin or any authorized user the ability to insert different rates for different cargo types. In addition, it will have a section that will allow the admin or any other authorized user to insert the load and discharge rates per crane per hour of each cargo type. After the admin or any authorized user insert and configure the new port, the users can start calculating any Disbursement Account for that port accurately. This Port Disbursement Account system is also a part of bigger system.

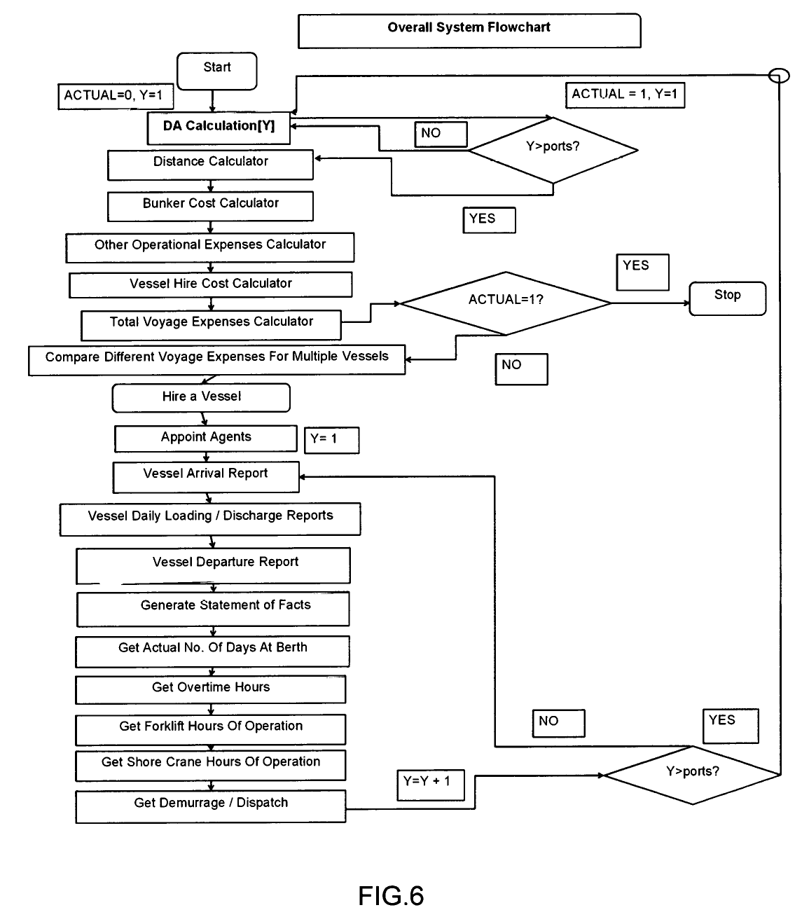

As shown above in FIG. 6, the overall system consists of multiple linked parts which lead to calculate total expenses of a vessel's voyage. Voyage expenses calculation can be calculated by summing up the DA expenses for each port in the voyage, bunker expenses, vessel hire expenses and other operational expenses. So, calculating an accurate DA will result to more accurate voyage expenses estimation. Also, the system can calculate an actual voyage expenses after finishing the voyage and replacing the estimated parameters by the actual parameters. Most of the actual parameters can be retrieved from the software generated Statement of facts reports which consists of all the arrival, departure and daily operation details in each port. The online Statement of Facts will be automatically generated after the agent inserts the arrival, departure and daily operation details in the overall system. Then the system will be able to analyze the remarks of the statement of facts and get the actual number of days at berth, actual overtime hours, actual forklift hours, actual extra shore cranes hours and demurrage/dispatch calculation. Finally, using these actual parameters the overall system allows the user to recalculate the actual Disbursement Account and Voyage Expenses.

What is claimed is:

1. A computerized method to calculate any Port Disbursement Account with breakdown of every item for any port regardless of the differences in port tariffs, port rules and ways of calculating any item in a Disbursement Account, comprising the steps of: inserting and storing the port tariff rates and rules for any new port in few minutes using simple configurations steps without any additional programming; and an algorithm capable of using the user inputs, the stored port tariff rates and the pre-defined rules in calculating all the elements of a Disbursement Account.

2. The computerized method in claim 1, configurations further comprising the steps of: adding a new country; adding a new port within the country; and inserting the pre-defined port tariffs and rules of each subcategory under the port expenses, cargo expenses and other expenses categories.

3. The computerized method in claim 2, inserting the pre-defined port tariffs and rules further comprising the steps of: inserting the time limit range of the subcategory; inserting the capacity limit range of the subcategory; inserting the rate of each time limit range and capacity limit range; inserting the rate ratio for each rate; inserting the rate unit for each rate; setting the corresponding cargo types for each rate; inserting the number of equipment's used in the operation for the subcategory; and setting the AND Condition flag of the subcategory.

4. The computerized method in claim 1, wherein user inputs are country, port, operation details, cargoes details, vessel details and voyage details.

5. The computerized method in claim 4, further comprising the steps of using Country, Port, Vessel Flag, Operation Type, Operation Terms, Cargo Type, Cargo Quantity, Shore Crane Capacity, GRT (Gross Tonnage), NRT (Net Tonnage), DWT (Dead Weight Tonnage), LOA (Length Over All), Draft, Width, Depth Moulded, Number of Cranes and Vessel ETB (Expected Time of Berthing) as user inputs.

6. The computerized method in claim 1, algorithm further comprising the steps of: retrieving the user inputs; retrieving the categories and subcategories based on the user selected port; calculating the expected number of days at berth; calculating each subcategory in the cargo expenses category; calculating each subcategory in the port expenses category; calculating each subcategory in the other expenses category; and displaying the Port Disbursement Account with the breakdown of each subcategory or element.

7. The computerized method in claim 6, calculating the expected number of days at berth further comprising the steps of: retrieving the load or discharge rate per crane per hour using the selected operation type and the selected cargo type; calculating the cargo quantity handled by one crane by dividing the inserted cargo quantity by the inserted number of cranes; calculating the number of hours at berth by dividing the calculated cargo quantity handled by one crane by the retrieved load or discharge rate per crane per hour; and calculating the number of days at berth by dividing the calculated number of hours at berth by 24.

8. The computerized method in claim 6, calculating each subcategory further comprising the steps of: initializing the Final Rate variable to the value of zero; checking all the capacity and time limits to find the rate object; checking the AND Condition flag of the subcategory; storing the rate object; calling the rate unit function for setting the values of the stored rate object; and calculating the Final Rate variable using the DA Formula.

9. The computerized method in claim 8, calling the rate unit function further comprising the steps of: setting the values of rateunitvalue[0], rateunitvalue[1], rateunitvalue[2], ratevalue and ratio using the stored rate object, rate unit of the stored rate object and inserted user inputs.

10. The computerized method in claim 9, calculating the Final Rate variable further comprising the steps of: retrieving the rate object; retrieving the stored Final Rate value; and calculating the Final Rate variable by adding the stored Final Rate value with the multiplication of rateunitvalue[0], rateunitvalue[1], rateunitvalue[2], ratevalue and (1 divided by ratio) of the retrieved rate object.

11. The computerized method in claim 1, further comprising the step of re-calculating the actual Disbursement Account by replacing the estimated parameters with the actual parameters after extracting them from the software generated Statement of Facts report.

12. The computerized method in claim 1, further comprising the steps of: retrieving the calculated Disbursement Account and use it in calculating the Voyage Expenses; calculating the traveling distance; calculating the bunker expenses; calculating the other operational expenses; and calculating the total hire expenses.

13. The computerized method in claim 12, further comprising the step of calculating the Voyage Expenses by adding the retrieved Disbursement Account for all the ports in the voyage, calculated bunker expenses, calculated other operational expenses and calculated total hire expenses of the voyage.

14. The computerized method in claim 1, further comprising the step of re-calculating the actual Voyage Expenses by inserting the actual Disbursement Account and the actual parameters after extracting them from the software generated Statements of Facts reports of all the ports in the voyage.

15. The computerized method in claim 14, further comprising the steps of: calculating the actual number of days at berth, the actual overtime hours, the actual forklift hours of operation, the actual shore crane hours of operation, the actual demurrage and dispatch from the software generated Statement of Facts reports.
